(19) United States
(12) Patent Application Publication
(10) Pub. No.: US 2004/0062914 A1
(43) Pub. Date: Apr. 1, 2004

(54) Multifunction strap for handle

(76) Inventor: Mao-Hsiu Wang, Taichung Hsien (TW)

Correspondence Address: BACON & THOMAS, PLLC, 625 SLATERS LANE, FOURTH FLOOR, ALEXANDRIA, VA, 22314

(21) Appl. No.: 10/320,457

(22) Filed: Dec. 17, 2002

(30) Foreign Application Priority Data
Sep. 26, 2002 (TW) 91215218

(51) Int. Cl. B32B 3/02; B32B 3/10

(52) U.S. Cl. 428/157; 428/138

(57) ABSTRACT

A strap for winding on a handle is disclosed to include a strap body having a gripping layer made of rubber and located on a top side of the strap body for holding by a user's hand, and a bottom layer bonded at a top surface thereof with a bottom surface of the gripping layer and having a ductility smaller than that of the gripping layer. The gripping layer has a transverse width grater than that of the bottom layer. The gripping layer is provided at one of two lateral sides thereof with a protrusion lip on which a recessed portion is formed and the said recessed portion forms a guiding line at a position where the recessed portion is adjacent to a top surface of the gripping layer.

### FIELD OF THE INVENTION

The present invention relates to a strap, and more particularly to a multi-functional strap for winding around the handle of a sports apparatus such as tennis racket, badminton racket, golf club, baseball bat, hockey bat, etc.

### BACKGROUND OF THE INVENTION

The conventional strap generally comprises a gripping layer, a nonwoven cloth layer and a bottom layer, or simple structure with a gripping layer 1 and a nonwoven cloth layer 2 as indicated in FIG. 1 and FIG. 2. The gripping layer 1 is generally made of polyurethane (PU) foam to offer a comfortable gripping feeling. However, a drawback for PU foam comes as: when the strap is twined around a handle in a spiral way, the outer layer made of polyurethane foam is stretched much than the inner layer made of nonwoven cloth because the outer layer has a greater radius of curvature than the inner layer, thus making the PU foam of the gripping layer 1 a slight over-stretch or damage due to a greater extension in the process of preload winding that leads to a poor shock-absorbing effect or a short service life.

Besides, even the PU foam enables hands to achieve a better comfort, the high-speed hitting shall make a loosening racket sometimes as a result of PU foam having no anti-slippery feature that would jeopardize onlookers' safety. In a word, the gripping layer 1 made of PU material brings out drawbacks such as poor shock-absorbing effect, short service life and easy slip. Moreover, there is no standard to follow in the process of twining the strap around the handle, slower twining speed along with the different width of the overlap for the side edge of the strap body consequently brings a tangly condition after twining.

### SUMMARY OF THE INVENTION

The primary objective of the present invention is to provide a multifunction strap with its gripping layer having characteristics of ductility and greater density that make a better shock-absorbing effect and longer service life.

The secondary objective of the present invention is to provide a multifunction strap with better anti-slippery feature.

Another objective of the present invention is to provide a multifunction strap that can make a swift and well-arranged twine around a handle.

To keep the objectives of the present invention, the present invention provides a strap for winding on a handle comprising a strap body having a gripping layer made of rubber and located on a top side of the strap body for holding by a user's hand, and a bottom layer bonded at a top surface thereof with a bottom surface of the gripping layer and having a ductility smaller than that of the gripping layer. The gripping layer has a transverse width grater than that of the bottom layer. The gripping layer is provided at one of two lateral sides thereof with a protrusion lip on which a recessed portion is formed and the recessed portion forms a guiding line at a position where the recessed portion is adjacent to a top surface of the gripping layer.

Moreover, the thickness of the gripping layer is less than that of the bottom layer, not only displaying feature of the rubber gripping layer but the feature of the bottom layer as well.

### BRIEF DESCRIPTION OF THE DRAWINGS

FIG. 1 shows a perspective view of a conventional strap wound around the handle of a golf club;

FIG. 2 shows an enlarged sectional view taken along the direction indicated by a line 2-2 as shown in FIG. 1;

FIG. 3 shows a perspective view of a first preferred embodiment of the present invention;

FIG. 4 shows a sectional view of a second preferred embodiment of the present invention;

FIG. 5 shows a sectional view of a third preferred embodiment of the present invention;

FIG. 6 shows a sectional view of a fourth preferred embodiment of the present invention;

FIG. 7 is a schematic view showing deformation of the strap of FIG. 6 pressed by hand;

FIG. 8 shows a perspective view of the strap of FIG. 6 wound around the handle of a golf club;

FIG. 9 shows a sectional view of a fifth preferred embodiment of the present invention.

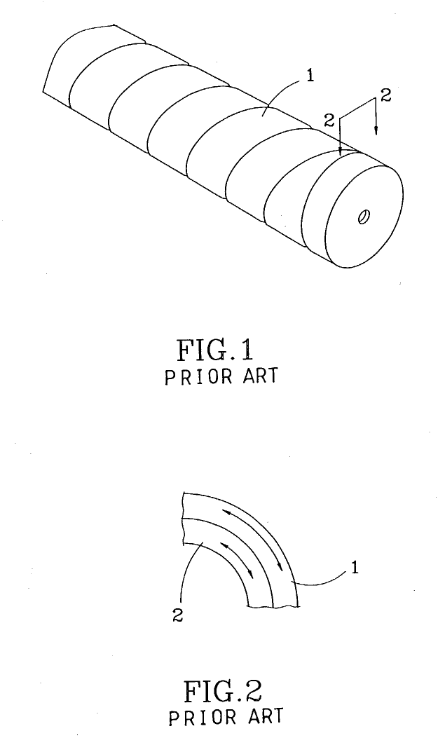

### DETAILED DESCRIPTION OF THE INVENTION

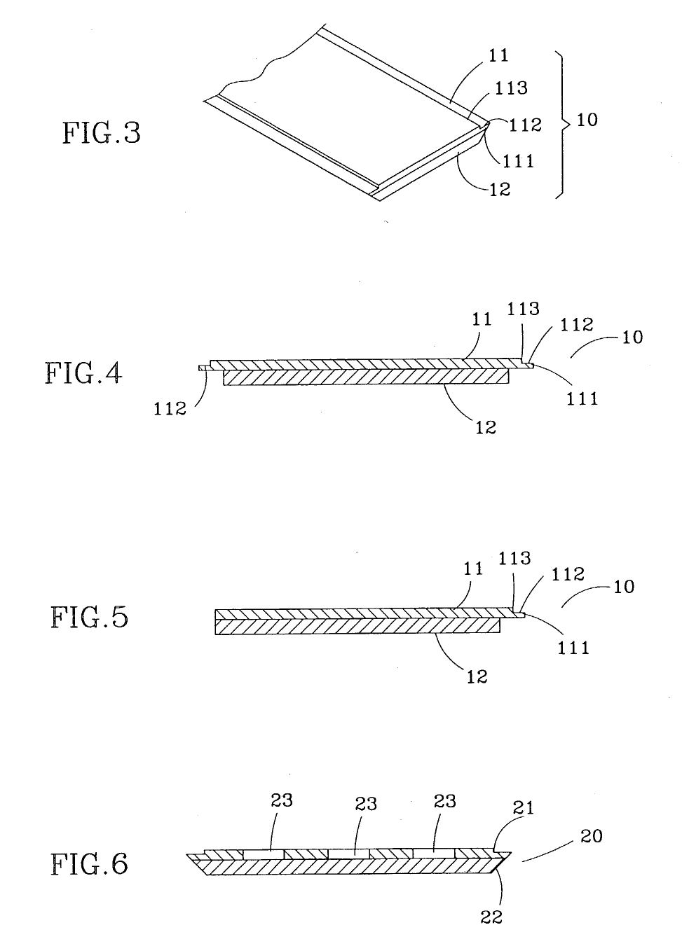

As shown in FIG. 3, the strap provided by the first preferred embodiment of the present invention comprises a strap body 10 to be wound around the handle of a sports apparatus in a spiral way. The strap body 10 has a gripping layer 11 which is on the top of the strap body 10 conveniently for a hold by hands, and a bottom layer 12 bonded at the top surface thereof to the bottom surface of the gripping layer 11. The gripping layer 11 is preferably made of rubber which has characteristics of a high ductility, density and good anti-slippery effect. Wherein the effect of the high ductility prevents an over-stretch damage or a short service life due to a greater bending rate and ductility in the process of preload winding. The high density effect brings a better shock-absorbing effect. Besides, the anti-slippery effect avoids a loosening racket under a high-speed hitting. The thickness along the longitudinal axis of the gripping layer 11 is uniform and has preferably a range between 0.3 mm˜1.2 mm. The gripping layer is provided at the two lateral sides thereof with a protrusion lip 111 respectively. Each protrusion lip 111 has a recessed portion 112 which defines a guiding line 113 with the top surface of the gripping layer 11. That is, the guiding line 113 is formed at the position where the recessed portion 112 is closely adjacent to the top surface of the gripping layer. The bottom layer 12 is made of a material, such as polyurethane (PU) or EVA, having a ductility and a density both smaller than the gripping layer 11. The bottom layer made of PU enhances a better gripping and the bottom layer made of EVA brings a better shock-absorbing effect. The bottom layer can be also made of other shock-absorbing materials. The thickness along the longitudinal axis of the bottom layer 12 is uniform and has preferably a range between 0.8 mm˜1.6 mm. It is to be noted that thickness of the gripping layer 11 is less than or equal to the thickness of the bottom layer 12, keeping the thickness ratio of the gripping layer to the bottom layer under or equal to 1, thus not only exhibiting the feature of rubber of the gripping layer 11 but also the comfort or shock-absorbing effect of the bottom layer 12. When the user winds the strap on a handle, one of the bottom lateral sides is overlapped on the opposite recessed portion 112 along the guiding line 113 to form a well-arranged overlapped connection with sense of beauty.

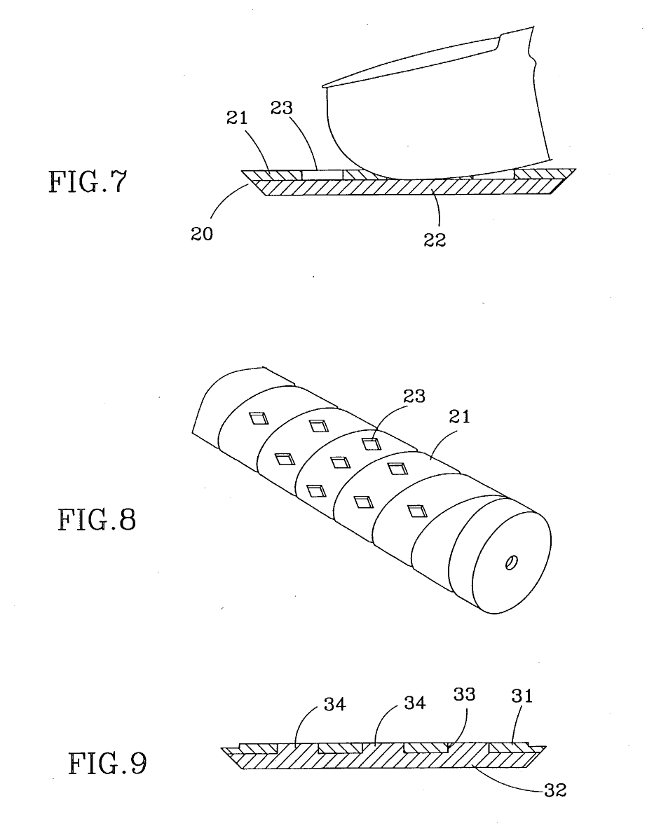

The second preferred embodiment of the present invention as shown in FIG. 4 differs from the first preferred embodiment in that the shape of the protrusion lip 111 of the gripping layer 11 is different from that of the first preferred embodiment and it can provide different method of overlap for twine. The third preferred embodiment of the present invention as shown in FIG. 5 differs from the second preferred embodiment in that there is only one side of the gripping layer 11 having the protrusion lip 111 while there is none for the other side. The fourth preferred embodiment of the present invention as shown in FIG. 6 differs from the first preferred embodiment in that the gripping layer 21 of the strap body 20 has a plurality of through holes 23. The shape of the through holes can be in round, square, diamond or irregular shapes with the internal diameter thereof at least in 4 mm˜8 mm, and the vertical depth of the through holes is equal to the thickness of the gripping layer 21. When the strap is pressed by hands, the edges of the through holes 23 of the gripping layer 21 of the strap body 20 will be dented to a level close to the top surface of the bottom layer 22, thus making hands to be able to touch both the gripping layer 21 and bottom layer 22. The detailed description is given as follows: while the gripping layer 21 of the strap is made of rubber and the bottom layer 22 made of PU, hands may make a direct contact with the gripping layer 21 which has the anti-slippery effect, and at the same time as indicated in FIG. 7 pressing each through hole 23 of the gripping layer 21 will make the gripping layer 21 adjacent to the edge of the through holes 23 to be dented to the comfortable bottom layer 22 which shall make a direct contact with hands that further can bring the features of the materials for gripping layer 21 and bottom layer 22 into a full play. The shape of the through holes 23 can be round, square or diamond as shown in FIG. 8, or a design pattern such as name of trademark or logo, making the design of the strap more pleasant to the eyes that would allure customers' attraction to achieve a better practicability for the product.

The fifth preferred embodiment of the present invention as shown in FIG. 9 differs from the fourth preferred embodiment in that the bottom layer 32 of the strap body 30 is provided at the top surface thereof with a plurality of protrusions 34 received in the through holes 33 of the gripping layer 31 to not only enhance a connection between the bottom layer and the gripping layer but also increase the contact of the user's hands and the bottom layer. It is to be note that the bottom layer 32 in the present embodiment is made of PU. However, it can be replaced with EVA foam or other shock-absorbing materials.

In conclusion, the advantages of the present invention are recited as follows.

1. Long service life and good shock-absorbing and anti-slippery effect:

The rubber gripping layer of the strap brings a good extension and anti-slippery effect, whereas it not only avoids a damage of the grip structure arising out of a greater degree of ductility that results in a short service life but also possesses shock-absorbing effect and prevents loosening due to a high-speed hitting.

2. Effect of a dual-layer characteristics:

The thickness of the gripping layer is less than the thickness of the bottom layer or the bottom layer are exposed outside via the through holes of the gripping layer, thereby enabling hands to feel not only the rubber feature of the gripping layer but a comfort and shock-absorbing effect provided by different materials of the bottom layer.

3. Well-arranged appearance:

As there is a guiding line available for winding process while working on the handle, it consequently brings a swift winding speed and forms a well-arranged condition after the winding operation due to the same width of the overlap part for the side edge of the strap body. The shape of each through hole of the gripping layer and the pattern formed by the through holes with the different colors of bottom layer bring a presentation of contrast can thus satisfy consumers' vision on the one hand and stimulate their purchase intention on the other hand.

What is claimed is:

1. A strap for winding on a handle, comprising:
a strap body having a gripping layer made of rubber and located on a top side of the strap body for holding by a user's hand, and a bottom layer bonded at a top surface thereof with a bottom surface of the gripping layer and having a ductility smaller than that of the gripping layer, said gripping layer having a transverse width grater than that of the bottom layer; wherein the gripping layer is provided at one of two lateral sides thereof with a protrusion lip on which a recessed portion is formed and said recessed portion forms a guiding line at a position where the recessed portion is adjacent to a top surface of the gripping layer.

2. The strap as defined in claim 1, wherein the gripping layer is provided at the other lateral side thereof with a protrusion lip.

3. The strap as defined in claim 1, wherein the thickness of the gripping layer is smaller than that of the bottom layer.

4. The strap as defined in claim 3, wherein the thickness of the gripping layer ranges from 0.3 mm˜1.2 mm and the thickness of the bottom layer ranges from 0.8 mm˜1.6 mm.

5. The strap as defined in claim 1, wherein the bottom layer is made of polyurethane.

6. The strap as defined in claim 1, wherein the bottom layer is made of EVA foam.

7. The strap as defined in claim 1, wherein the gripping layer has a plurality of through holes.

8. The strap as defined in claim 7, wherein the top surface of the bottom layer has a plurality of protrusions received in said through holes respectively.

9. The strap as defined in claim 7, wherein the shape of the through hole is round.

10. The strap as defined in claim 7, wherein the shape of the through hole is designed in square shape.

11. The strap as defined in claim 7, wherein the shape of the through hole is designed in diamond shape.

12. The strap as defined in claim 7, wherein the through hole has a diameter between 4 mm to 8 mm.

13. The strap as defined in claim 1, wherein the density of the gripping layer is larger than that of the bottom layer.
